(19) United States
(12) Patent Application Publication
(10) Pub. No.: US 2017/0011357 A1
(43) Pub. Date: Jan. 12, 2017

(54) JOB EXECUTION CALENDAR MANAGEMENT DEVICE AND JOB EXECUTION CALENDAR MANAGEMENT METHOD

(71) Applicant: FUJITSU LIMITED, Kawasaki-shi (JP)

(72) Inventors: Yuta Kojima, Nagoya (JP); Shinji Nagasawa, Kawasaki (JP); Takamasa Ohashi, Toyoake (JP); Kazuyuki Sakai, Nissin (JP); MASASHI KATOU, Nagoya (JP); Eiichi Higuchi, Toyota (JP); Masahiro FUKUDA, Nagoya (JP)

(73) Assignee: FUJITSU LIMITED, Kawasaki-shi (JP)

(21) Appl. No.: 15/196,786

(22) Filed: Jun. 29, 2016

(30) Foreign Application Priority Data
Jul. 10, 2015 (JP) 2015-139000

(51) Int. Cl. G06Q 10/10; G06F 17/30

(52) U.S. Cl. CPC G06Q 10/1097; G06F 17/30952

(57) ABSTRACT

A job execution calendar management device includes a processor configured to acquire, from an information processing system, first pieces of calendar information respectively indicating timings for starting first jobs, access table information indicating which one of first tables has been accessed respectively by the first jobs, and type information indicating a type of respective data manipulations performed on the first tables through the accesses by the first jobs. The information processing system starts the first jobs on basis of the first pieces of calendar information. The processor is configured to identify transaction tables storing information added by any one of the first jobs, among the first tables on basis of the type information and group second pieces of calendar information among the first pieces of calendar information on basis of the access table information. The second pieces of calendar information correspond to second jobs accessing a same transaction table.

### CROSS-REFERENCE TO RELATED APPLICATION

This application is based upon and claims the benefit of priority of the prior Japanese Patent Application No. 2015-139000 filed on Jul. 10, 2015, the entire contents of which are incorporated herein by reference.

### FIELD

The embodiment discussed herein is related to a Job execution calendar management device and a job execution calendar management method.

### BACKGROUND

In an office, data processing related to a business is defined as a job executed by a computer, and automation of the job using the computer is performed. When the computer is capable of executing a plurality of jobs, execution of the plurality of jobs may be intensively managed using software called a job scheduler. The job scheduler receives registration of the plurality of jobs, and performs a job management such as scheduling of execution of the plurality of jobs such that the registered plurality of jobs are efficiently executed.

In recent years, the flow of integrating, into a data center, information and communication technology (ICT) systems, which have been present in physically dispersed environments, for the purpose of a control and cost reduction has been accelerated for a few years. This results in an increase of operations in a style in which a large amount of ICT resources are collectively managed and operated in a concentrated manner in a large-scale data center.

Related techniques are disclosed in, for example, Japanese Laid-Open Patent Publication No. 04-076632, Japanese Laid-Open Patent Publication No. 05-282164, and Japanese Laid-open Patent Publication No. 2003-067186.

The cost of ICT resources may be reduced by integration of the ICT resources through virtualization. However, even when the ICT resources are integrated by virtualization as described above, business systems to be managed remain individual, and thus, a reduction of business operation and management cost has not been achieved.

In a case of a batch business, for each base where a business system has been arranged or each person in charge of a business, information (for example, a calendar) for operating is individually defined and managed. Thus, only by simply performing the server integration through virtualization, for example, the number of calendar definitions to be managed is not reduced from a level of thousands or tens of thousands, thereby causing a degradation of operation quality due to a wrong operation.

Calendar definitions may not be easily integrated because the calendar definitions are dependent on the business processing, and the execution date and time of a job varies depending on business processing.

Further, even when the regularity (e.g. Monday to Friday) of job scheduling of calendars is common, whether this coincidence is caused by chance or is caused due to a relationship between calendars may not be distinguished. Thus, in a case where there is an individual change of, for example, a factory working day, commonization by only regularity may cause a hindrance.

### SUMMARY

According to an aspect of the present invention, provided is a job execution calendar management device including a processor. The processor is configured to acquire first pieces of calendar information, access table information, and type information from an information processing system. The first pieces of calendar information respectively indicate timings for starting first jobs. The information processing system starts the first jobs on basis of the first pieces of calendar information. The access table information indicates which one of first tables has been accessed respectively by the first jobs. The type information indicates a type of respective data manipulations performed on the first tables through the accesses by the first jobs. The processor is configured to identify transaction tables among the first tables on basis of the type information. The transaction tables store information added by any one of the first jobs. The processor is configured to group second pieces of calendar information among the first pieces of calendar information on basis of the access table information. The second pieces of calendar information correspond to second jobs among the first jobs. The second jobs access a same transaction table among the transaction tables.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary job execution calendar management device in the present embodiment;

FIG. 2 illustrates an exemplary business system in the present embodiment;

FIG. 3 illustrates an exemplary job name/table name relationship table in the present embodiment;

FIG. 4 illustrates an exemplary type relationship table in the present embodiment;

FIG. 5 illustrates an exemplary type relationship table in the present embodiment;

FIG. 6 illustrates an exemplary table access information table in the present embodiment;

FIG. 7 illustrates an exemplary table access information table in the present embodiment;

FIG. 8 illustrates an exemplary periodicity table in the present embodiment;

FIG. 9 illustrates a processing flow of a calendar management device in the present embodiment;

FIG. 10 illustrates calendars which may be commonized depending on a business processing in the present embodiment;

FIG. 11 illustrates exemplary functional configurations of a business system and a calendar management device in the present embodiment;

FIGS. 12A and 12B illustrate exemplary job definition information in the present embodiment;

FIGS. 13A and 13B illustrate exemplary calendar definition information in the present embodiment;

FIG. 14 illustrates exemplary job/DB access information in the present embodiment;

FIG. 15 illustrates an exemplary business DB access log in the present embodiment;

FIG. 16 illustrates exemplary integrated job definition information in the present embodiment;

FIG. 17 illustrates exemplary integrated calendar definition information in the present embodiment;

FIG. 18 illustrates exemplary job/table/type relationship information in the present embodiment;

FIG. 19 illustrates exemplary periodicity information in the present embodiment;

FIG. 20 illustrates exemplary business processing unit information in the present embodiment;

FIG. 21 illustrates an operation flow at the execution of a batch job by a job scheduler prior to integration of business systems, in the present embodiment;

FIG. 22 illustrates a processing flow of an integration unit in a system integration stage in the present embodiment;

FIG. 23 illustrates a processing flow of table type determination (S23) in the present embodiment;

FIG. 24 illustrates a processing flow of commonization of calendars (S26) in the present embodiment;

FIGS. 25A and 25B illustrate commonization of calendars grouped in unit of business processing in the present embodiment; and

FIG. 26 illustrates an exemplary hardware configuration of a computer that executes a program in the present embodiment.

### DESCRIPTION OF EMBODIMENT

As described above, a function for reducing duplicate operation and management costs through integration of servers has not been provided.

In business integration of advanced customers, commonization of calendar definitions is performed by manpower. However, a labor requires a great deal of cost, and a problem may occur due to a human error.

Thus, a reduction of the number of management targets through mechanical commonization of calendar definitions, which does not require a labor, is required to realize a reduction of the operation and management costs through a business integration.

A business system or an individual sub-system within the business system usually has a corresponding relationship to the unit of a business purpose. A role of batch processing is to perform extraction, processing, or aggregation of various data in response to an input so as to obtain data of a business purpose.

A calendar definition that defines when the batch processing is to be executed is determined on the basis of a business purpose. For example, in order to securely receive a payment for a sold product before any date, an execution date of batch processing is fixed in a manner of determining when a payment check is to be performed, and determining a billing date by calculating a grace period until payment. That is, there is a common reference date of a business purpose between related processing.

As another example, in a case of a business managing a production process at a factory, it is necessary to perform a process management business for each factory. In such a case, a business purpose is set for each physical base, and a calendar definition depending on the base is managed.

As described above, in designing a business system, first, in unit (in an entire business system or an individual sub-system belonging to the business system) of business processing for achieving any purpose or in unit of base such as a factory, when the target data needs to be obtained is determined.

Next, when a series of individual batch processing for realizing acquisition of the target data before the deadline is to be executed is determined. Then, the calendar definition is created in accordance with the determination.

In the present embodiment, operation and management costs of a business are reduced by an approach in which a unit of a series of business processing (a job group) formed to achieve the business purpose is identified, and then calendars are commonized for each of the business processing units.

For example, when a plurality of pieces of calendar definition information which are individually defined and managed are the same calendar definition, the number thereof may be reduced by commonly using them, thereby reducing the management costs.

When there is always a time interval of, for example, three days, between a calendar definition for one business processing and a calendar definition for another business processing, the calendar definitions may be commonly used. For example, a calendar definition for one business processing may be set as a calendar definition compliant with a business purpose by performing a shift definition of three days. This makes the calendar definition intuitive and easy to understand, and thus the management costs may also be reduced.

In the present embodiment, the unit of a series of business processing (a job group) configured to achieve the business purpose is determined based on the property of a table to be managed in a database. In a business system, for example, a database table includes a master table corresponding to ledger information, and a transaction table corresponding to slip information generated by daily business processing. The master table includes, for example, a product master table (product name, product code, classification code, unit price, and the like), and a stock master table (product name, quantity, and the like). The transaction table includes, for example, a production record transaction table (product name, lot number, manufacturing date, quantity) and a shipping schedule/result transaction table (product name, shipping destination, scheduled shipping date and time, actual shipping date and time, transport means, and quantity).

Business processing having a connection relationship through the same slip information, that is, through the same transaction table, may be regarded as a unit of a series of business processing for achieving a business purpose. However, in a job for determining whether the operational state of the business system is normal by surveying the entire business, an access to the transaction table is made across units of business processing. Thus, the job is not regarded as a unit of a series of business processing even if the business processing have a connection relationship via the operation monitoring job.

Considering this point, in the present embodiment, it is determined whether calendar definitions are able to be commonized in the following method. Then, when the commonization is available, a merge is performed.

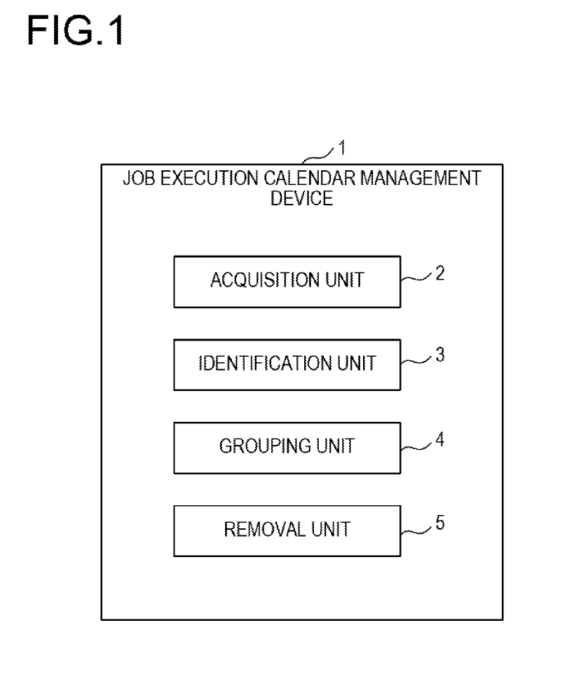

FIG. 1 illustrates an exemplary job execution calendar management device in the present embodiment. A job execution calendar management device 1 includes an acquisition unit 2, an identification unit 3, and a grouping unit 4.

The acquisition unit 2 acquires access table information, a plurality of pieces of calendar information, and type information from one or more information processing systems. The information processing system is configured to operate a plurality of jobs on the basis of the plurality of pieces of calendar information indicating timings for starting the plurality of jobs, respectively. The access table information indicates which one of a plurality of tables has been accessed by each of the plurality of jobs. The type information indicates a type of each of data manipulations performed on the plurality of tables through accesses of the plurality of jobs. Processing of the acquisition unit 2 may include, for example, S1 to be performed by a calendar management device 31 to be described later, or S21, S22, and S23-1 to be performed by an integration unit 52.

The identification unit 3 identifies, based on the type information, a transaction table, which is a table storing information added by any one of the plurality of jobs, among the plurality of tables. Processing of the identification unit 3 may include, for example, S2 to be performed by the calendar management device 31 (to be described later), or S23-4 to be performed by the integration unit 52.

The grouping unit 4 groups, among the plurality of pieces of calendar information, calendar information corresponding to jobs accessing the same transaction table among transaction tables, based on the access table information. Processing of the grouping unit 4 may include, for example, S5 to be performed by the calendar management device 31 (to be described later), or S26 to be performed by the integration unit 52.

With this configuration, in a system in which a job to be executed in accordance with the calendar information is running, a calendar used for respective business processing may be identified.

When the type information indicates addition of data to a table, the identification unit 3 determines the table as a transaction table.

With this configuration, determination is enabled as to whether a table to be accessed by a job is a master table or a transaction table.

The job execution calendar management device 1 further includes a removal unit 5. Based on job definition information defining a start-up condition and an operation in a case of an abnormal end for each of the plurality of jobs, the removal unit 5 removes a job that starts at a constant time interval and re-starts in a case of an abnormal end, from the plurality of jobs. Processing of the removal unit 5 may include, for example, S4 to be performed by the calendar management device 31 (to be described later), or S24 to be performed by the integration unit 52.

With this configuration, jobs for a business purpose may remain while excluding jobs for an operation monitoring purpose.

The grouping unit 4 extracts candidates of calendar information to be integrated as a result of grouping.

With this configuration, commonization of calendar information may be achieved.

The grouping unit 4 further groups the extracted candidates on the basis of a calendar period. The grouping unit 4 sets one candidate as reference calendar information for each of groups formed based on the calendar period, and associates jobs corresponding to other candidates with the reference calendar information. At the same time, the grouping unit 4 maintains the difference of days between the respective other candidates and the reference calendar information.

With this configuration, even for calendar information with different contents, commonization may be achieved.

Hereinafter, the present embodiment will be described in more detail. For the sake of simplicity of explanation, hereinafter, a function realized by executing a program will also be referred to as a program.

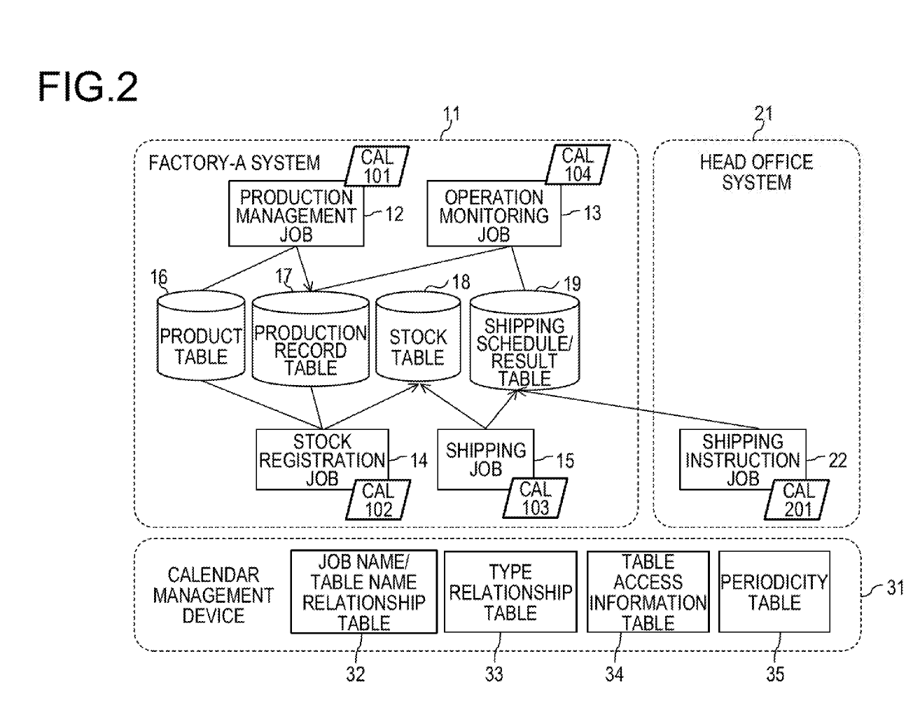

FIG. 2 illustrates an exemplary business system in the present embodiment. In FIG. 2, one or more servers forming a factory-A system 11, and one or more servers forming a head office system 21 are present.

In the head office system 21, a shipping instruction job 22 runs. The shipping instruction job 22 uses a calendar CAL201. The shipping instruction job 22 makes an instruction of recording shipping schedule information in a shipping schedule/result table 19 on the basis of head office business days (CAL201).

The factory-A system 11 includes a product table 16, a production record table 17, a stock table 18, and the shipping schedule/result table 19. A production management job 12, an operation monitoring job 13, a stock registration job 14, and a shipping job 15 run in the factory-A system 11.

The product table 16 is a table for managing products, and includes items such as, for example, a product name, a product code, a classification code, and a unit price.

The production record table 17 is a table for managing production records of products, and includes items such as, for example, a product name, a lot number, a manufacturing date, and a quantity.

The stock table 18 is a table for managing stocks of products, and includes items such as, for example, a product name and a quantity.

The shipping schedule/result table 19 is a table for managing shipping schedules of products and results, and includes, for example, a product name, a shipping destination, a scheduled shipping date and time, an actual shipping date and time, a transport means, and a quantity.

The production management job 12 uses a calendar CAL101. At the end of the working day (CAL101) of the factory-A, the production management job 12 records information of products manufactured in the factory-A on that day, in the production record table 17 with reference to the product table 16.

The stock registration job 14 uses a calendar CAL102. At the end of the working day (CAL102) of the factory-A, the stock registration job 14 reads information of the production record table, and updates the stock table 18 on the basis of the read information.

The shipping job 15 uses a calendar CAL103. At the end of the working day (CAL103) of the head office, the shipping job 15 records, in the shipping schedule/result table 19, information on shipping result from the factory-A and updates stock information registered in the stock table 18.

The operation monitoring job 13 uses a calendar CAL104. The operation monitoring job 13 monitors a state of increasing/decreasing data in each table on the basis of the calendar CAL104. When an abnormality is detected as a result of the monitoring, the operation monitoring job 13 sends a notification to a system administrator.

The calendar management device 31 manages calendars in which timings for executing jobs are set. Specifically, in the present embodiment, the calendar management device 31 identifies a unit of business processing from a stream of data used in batch processing after integration of batch systems, determines whether to integrate calendars, and integrates calendars having the same business purpose.

The calendar management device 31 includes a job name/table name relationship table 32, a type relationship table 33, a table access information table 34, and a periodicity table 35.

The job name/table name relationship table 32 is a table for managing which table is accessed by a job.

The type relationship table 33 is a table for managing a table type and a purpose type of a job. The table type indicates whether a corresponding table is a master table or a transaction table. The purpose type indicates whether a corresponding job is for a business or an operation monitoring.

The table access information table 34 is a table created for each entry registered in the job name/table name relationship table 32, and manages an access history for the target table.

The periodicity table 35 extracts the periodicity of the implementation timing of the data manipulation for the target table from the table access information table 34, and manages the extracted periodicity of the implementation timing of the data manipulation for the target table.

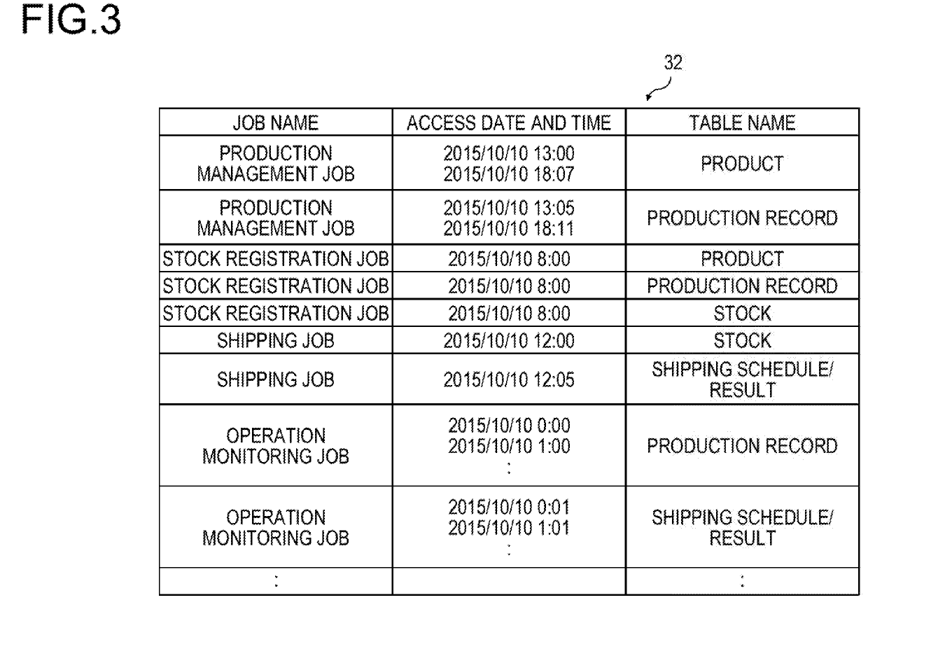

FIG. 3 illustrates an exemplary job name/table name relationship table in the present embodiment. Respective entries of the job name/table name relationship table 32 include items of “job name”, “access date and time”, and “table name”. In the “job name”, identification information for identifying a job is stored. In the “access date and time”, a date and time the job has accessed a corresponding table is stored. In the “table name”, identification information for identifying the table is stored.

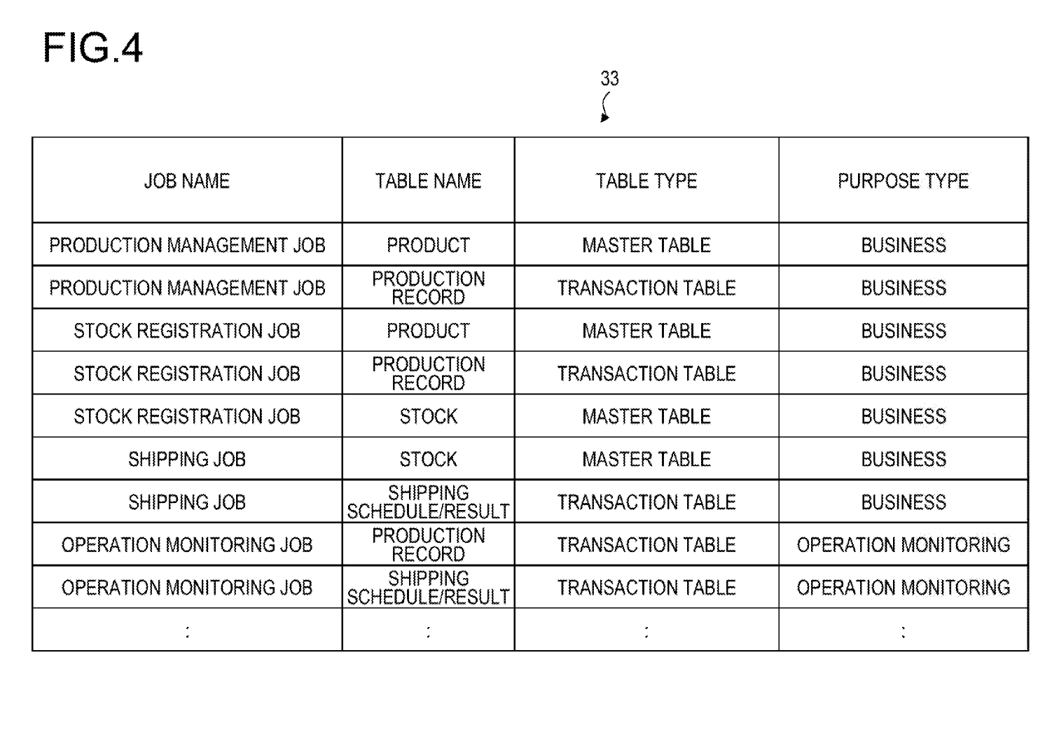

FIG. 4 illustrates an exemplary type relationship table in the present embodiment. Respective entries of the type relationship table 33 include items of “job name”, “table name”, “table type”, and “purpose type”. In the “job name”, identification information for identifying a job is stored. In the “table name”, identification information for identifying a table is stored. In the “table type”, type information indicating whether the table is a master table or a transaction table is stored. In the “purpose type”, type information indicating whether the job is for a business or an operation monitoring is stored.

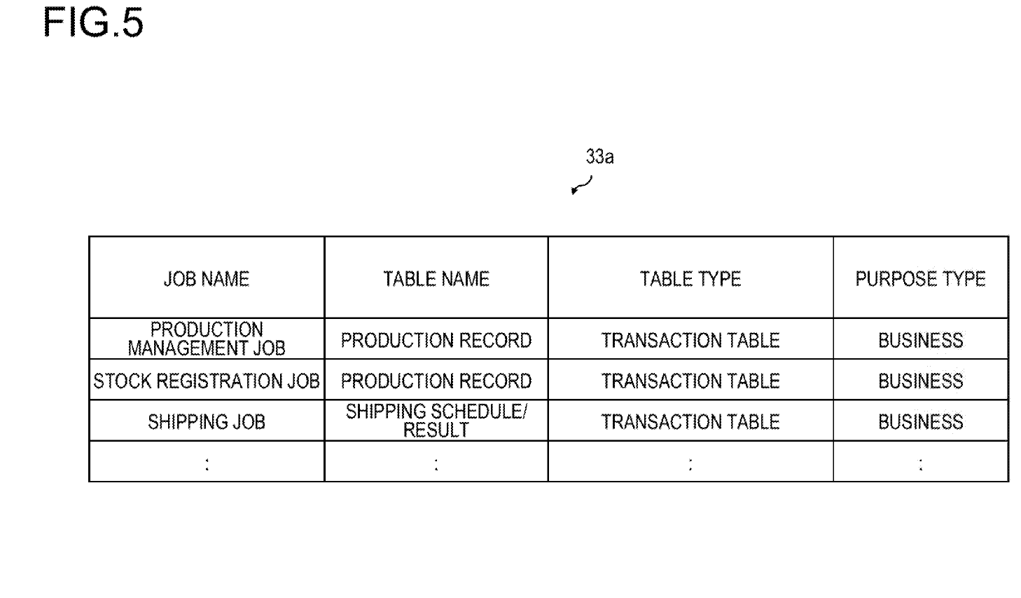

FIG. 5 illustrates an exemplary type relationship table in the present embodiment. A type relationship table 33a in FIG. 5 is the same as the type relationship table 33 in FIG. 4 except that entries having “master table” in the “table type” and entries having “operation monitoring” in the “purpose type” are excluded.

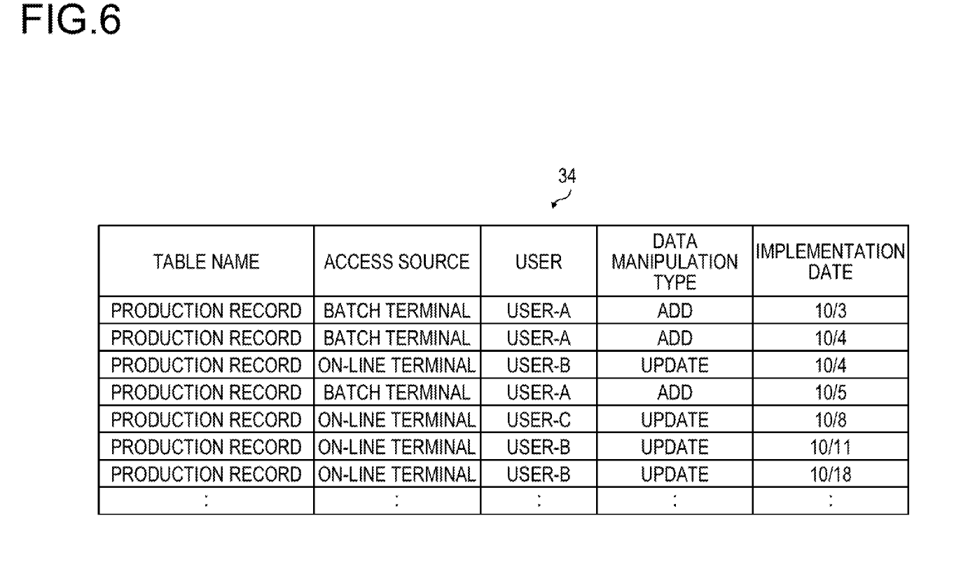

FIG. 6 illustrates an exemplary table access information table in the present embodiment. Respective entries in the table access information table 34 include items of “table name”, “access source”, “user”, “data manipulation type”, and “implementation date”.

In the “table name”, identification information for identifying a table is stored. In the “access source”, terminal information of an access source for the table is stored. In the “user”, information for identifying a user is stored. In the “data manipulation type”, the content (“update” or “add”) of data manipulation on the table is stored. In the “implementation date”, the date when the data manipulation has been implemented on the table is stored.

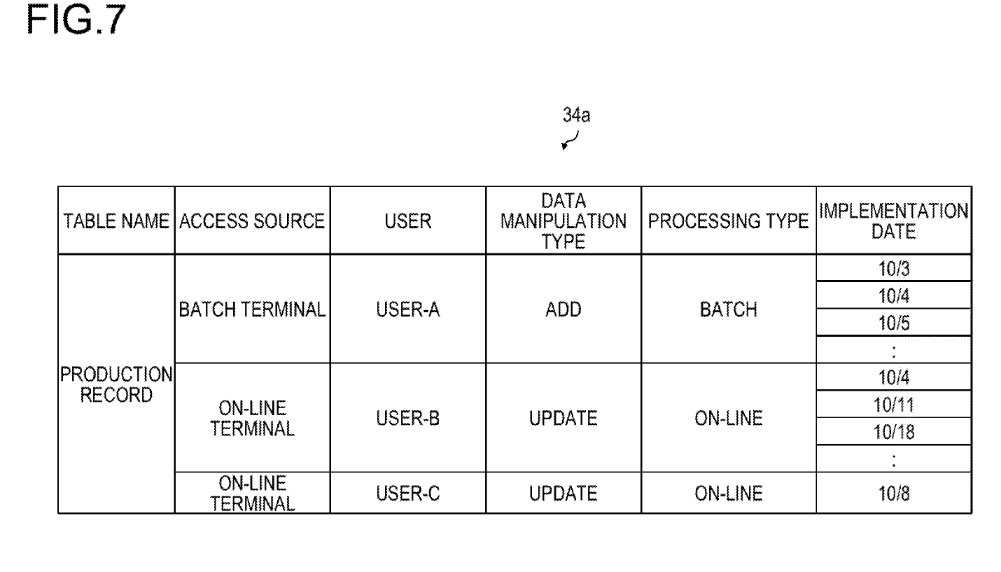

FIG. 7 illustrates an exemplary table access information table in the present embodiment. A table access information table 34a is the same as the table access information table 34 except that an item of “processing type” is added, in which the registered entries are grouped in order of a table name, an access source, a user name, and a data manipulation type, a processing type, and an implementation date.

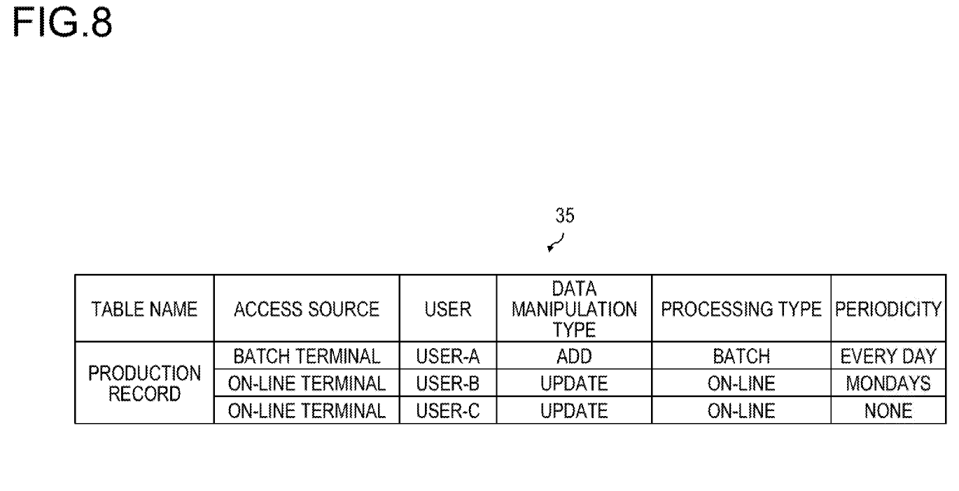

FIG. 8 illustrates an exemplary periodicity table in the present embodiment. Respective entries in the periodicity table 35 include items of “table name”, “access source”, “user”, “data manipulation type”, “processing type”, and “periodicity”.

In the “table name”, identification information for identifying a table is stored. In the “access source”, terminal information of an access source for the table is stored. In the “user”, information for identifying a user is stored. In the “data manipulation type”, the content (“update” or “add”) of the data manipulation on the table is stored. In the “processing type”, whether the data manipulation has been performed by batch processing or on-line processing is stored. In the “periodicity”, a periodicity of an execution timing of the data manipulation is stored.

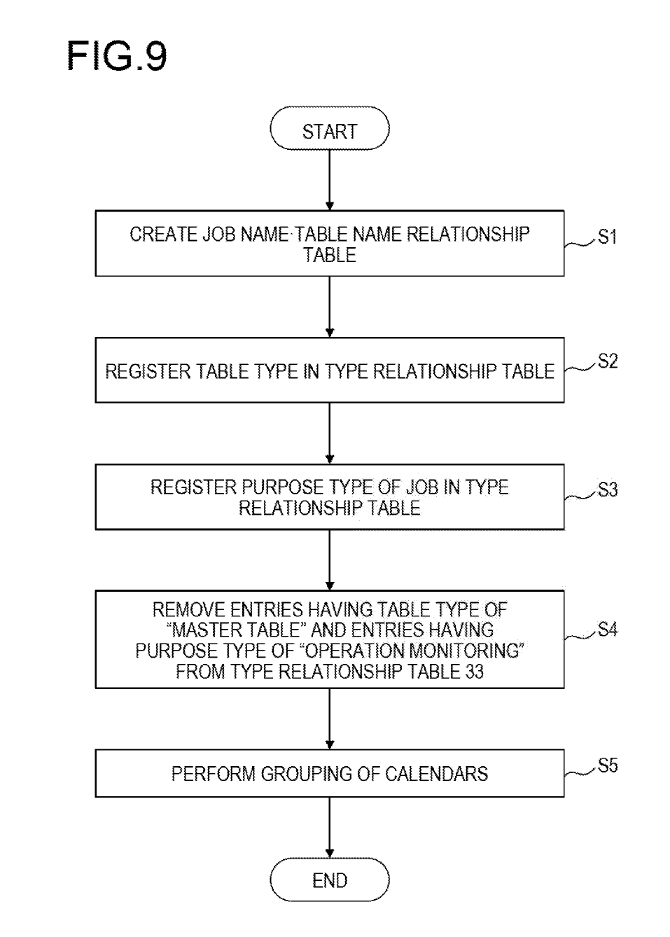

FIG. 9 illustrates a processing flow of a calendar management device in the present embodiment. The calendar management device 31, for each business system, acquires calendar information, a log, and job definition information, and creates a relationship table (a job name/table name relationship table 32) between a job name and a table name (S1). Specifically, the calendar management device 31 extracts, from a log for each business system, a structured query language (SQL) issued from a process of a job. The calendar management device 31 extracts which table is accessed by the job, from the extracted SQL. When extracting a job, a table accessed by the job, and an access date and time, from the log and the SQL, the calendar management device 31 registers the job, the table, and the access date and time in the job name/table name relationship table 32 in association with each other.

Each business system may extract, from a log, an SQL issued from a process of a job; extract, from the log and the SQL, a job, a table accessed by the job, and an access date and time; and create the job name/table name relationship table 32. Further, each business system may extract a data manipulation type performed on the table by the job, from the SQL. In this case, the calendar management device 31 may acquire the job name/table name relationship table 32 and the data manipulation type, from each business system.

Then, for each table name registered in the job name/table name relationship table 32, the calendar management device 31 determines a table type (master table/transaction table) by a method to be described later, and registers the determined table type in the type relationship table 33 (S2). Details of S2 will be described later.

Then, for each job name registered in the job name/table name relationship table 32, the calendar management device 31 determines a purpose type (business/operation monitoring) of the job by a method to be described later, and registers the determined purpose type in the type relationship table 33 (S3). Details of S3 will be described later.

Then, as illustrated in FIG. 5, the calendar management device 31 removes entries having a table type of “master table”, and entries having a purpose type of “operation monitoring”, from the type relationship table 33 (S4). Accordingly, in the type relationship table 33a, entries having a table type of “transaction” and a purpose type of “business” remain.

Then, the calendar management device 31 determines from the type relationship table 33a, that calendars of jobs having a table type of “transaction table”, and related to the same table name may be commonized. The calendar management device 31 groups the calendars determined to be commonized (S5).

Hereinafter, the determination method of a master table/transaction table in S2 will be described. A master table and a transaction table have the following properties.

In business processing by a daily batch, update of an entry of a master table may be performed or may not be performed. However, in business processing by a daily batch, addition of an entry is not performed on the master table.

For example, a type of master table in which determined contents are not changed, such as a product master table, is used for reference in business processing by a daily batch. However, addition and update of an entry are not performed on such a master table.

In a type of master table that holds a value that daily varies, the value may be updated every day. For example, in a stock master table that holds a stock quantity, the stock quantity may be updated every day. However, addition of an entry is not performed on such a master table at a daily level (in this case, addition of an entry means that the product line up increases).

Addition of an entry is performed on a master table at irregular intervals through a master maintenance work (batch/on-line) by a business manager. Since master data is basic information for performing the business and has an influence on the entire business processing, its management level is different from that of data which is updated by a daily batch. Therefore, addition of an entry on the master table may be performed by a separate user from update by a daily batch.

Meanwhile, addition of an entry is performed on the transaction table by business processing through a daily batch. Update of an entry may be performed or may not be performed on the transaction table.

For example, in a production record transaction table on a slip which is not expected to be updated after once issued, the number of entries is increased each time a commodity production is performed, and the contents are not updated. In a type of a transaction table in which addition of an entry is performed several times after a slip is issued, the number of entries is increased each time a shipping schedule is determined, and the result information is updated each time the shipping is actually performed.

In order to correct wrongly input data, in a transaction table, update of an entry is performed at irregular intervals by a batch/on-line process. This update is performed by a separate user from addition by a daily batch.

The calendar management device 31 makes a determination by the following method, using the properties of a master table and a transaction table.

(i) When adding or updating an entry in a table, the calendar management device 31 extracts a table name, an access source, a user, a data manipulation type, and an implementation date from a log and an SQL within the log, and registers these items in the table access information table 34 as illustrated in FIG. 6. The data manipulation type may be determined on the basis of the content (UPDATE/INSERT) of a data manipulation language (DML) of the SQL.

(ii) The calendar management device 31 adds an item of “processing type” to the table access information table 34, based on the job name/table name relationship table 32 of FIG. 3.

For the item of “processing type”, the calendar management device 31 collates a target table of the table access information table 34 with the job name/table name relationship table 32 of FIG. 3. As a result of the collation, when the access to the target table has been performed by an extension of batch processing, the calendar management device 31 determines the processing type as “batch” processing. Otherwise, the calendar management device 31 determines the processing type as “on-line” processing. The calendar management device 31 registers the determination results in the item of “processing type” of the table access information table 34.

The calendar management device 31 groups entries stored in the table access information table 34, in order of items of a table name, an access source, a user name, and a data manipulation type, a processing type, and an implementation date as illustrated in FIG. 7.

The calendar management device 31 obtains a period of the implementation date of the data manipulation for a target table from the grouped table access information table 34a. The calendar management device 31 registers the obtained period in the item of “periodicity” of the periodicity table 35 as illustrated in FIG. 8. Accordingly, the calendar management device 31 may determine whether the periodicity of the implementation date is present or not.

(iii) When it is determined that a target table has no periodic access information (entry) in the periodicity table 35, the calendar management device 31 determines that the target table is a master table.

When there is at least one entry indicating “add” in the data manipulation type for a target table in the periodicity table 35, the calendar management device 31 determines that the target table is a transaction table. When there is no entry indicating “add” in the data manipulation type for a target table in the periodicity table 35 and at least one entry indicating “update” in the data manipulation type is present, the calendar management device 31 determines that the target table is a master table.

Hereinafter, the method of determining the purpose type (business/operation monitoring) of a job in S3 will be described.

A job for the purpose of operation monitoring and a job for the purpose of business processing have the following properties, respectively.

A job for the purpose of operation monitoring is intended to steadily monitor a system, and thus is operated at fixed time intervals. The job for the purpose of operation monitoring is intended to continuously collect information. Thus, start-up of the job for the purpose of operation monitoring is repeated at the next and subsequent times even if an unexpected error occurs.

Meanwhile, a job for the purpose of business processing is intended to securely process business data. Thus, when an unexpected error occurs, the start-up of the job for the purpose of business processing is inhibited at the next and subsequent times until a system administrator finds solutions to deal with the problem.

By using these properties, the calendar management device 31 determines jobs of which the “start-up condition” is “constant time interval” and the “handling at abnormal end” is “start-up at next time” as jobs for the purpose of operation monitoring, and determines other jobs as jobs for the purpose of business processing. The calendar management device 31 registers the determination results in the type relationship table 33.

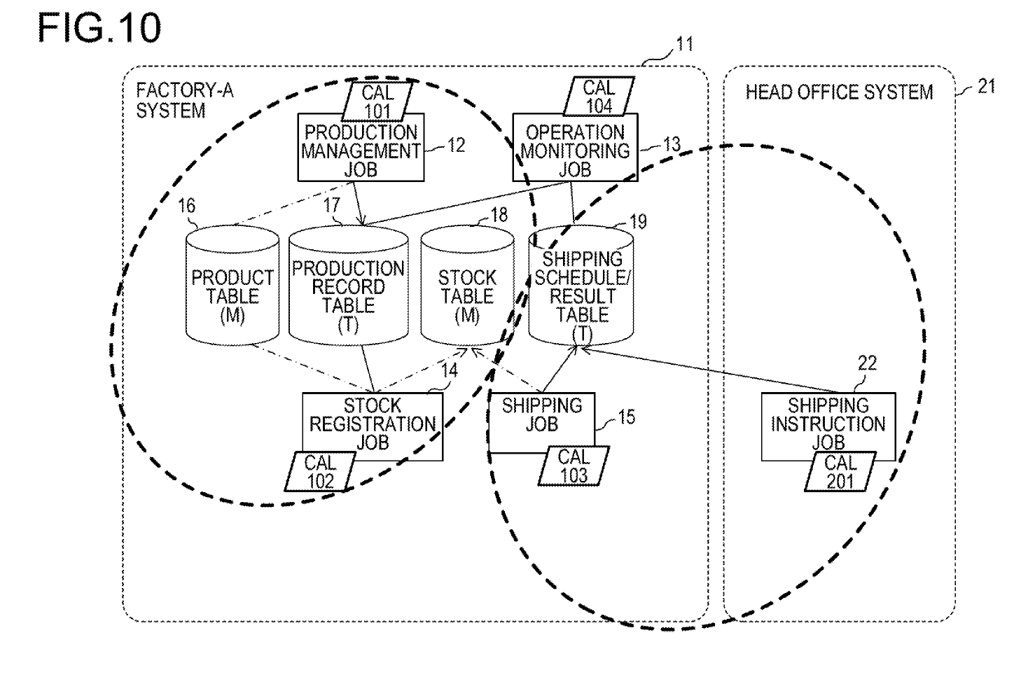

FIG. 10 illustrates calendars which may be commonized depending on business processing in the present embodiment. The calendar management device 31 determines based on the type relationship table 33a that the calendars CAL101 and CAL102 respectively used for the production management job 12 and the stock registration job 14 that access the production record table 17 as a transaction table may be used in common.

Also, the calendar management device 31 determines based on the type relationship table 33a that the calendars CAL201 and CAL103 respectively used for the shipping instruction job 22 and the shipping job 15 that access the shipping schedule/result table 19 as a transaction table may be used in common.

Hereinafter, examples of the above-described embodiment will be described.

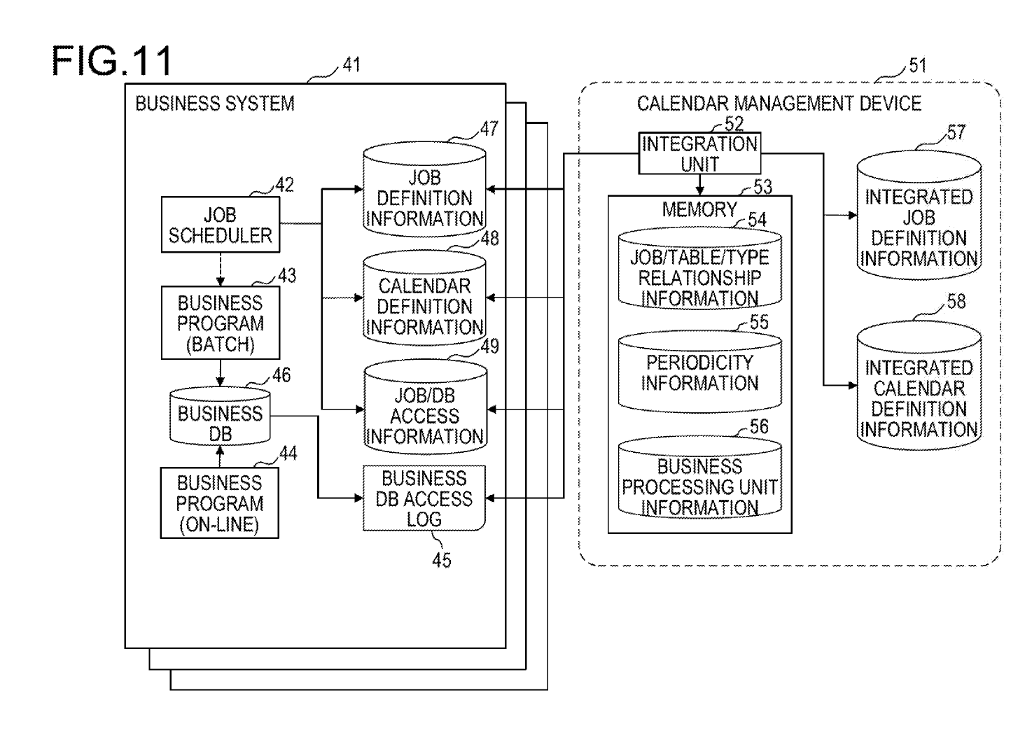

FIG. 11 illustrates exemplary functional configurations of a business system and a calendar management device in the present embodiment. One or more business systems 41 are present. Each business system 41 includes at least one server that runs each business system before virtually integrated. The business system 41 includes, for example, the factory-A system 11 and the head office system 21 of FIG. 2.

A controller (not illustrated) of the business system 41 executes a job scheduler 42, a business program 43 (batch), and a business program 44 (on-line). A storage device (not illustrated) included in the business system 41 stores therein a business DB 46, job definition information 47, calendar definition information 48, job/DB access information 49, and a business DB access log 45.

The job scheduler 42 is a program for managing a schedule of a job. The job scheduler 42 automatically starts the job in accordance with the definition of the job start-up condition defined in the job definition information 47, or performs the manipulation of the job or the management of the execution status or execution results.

The job definition information 47 is definition data of a job. In the job definition information 47, information indicating a name of a business program to be started, a start-up condition (e.g., in time, file waiting), and which calendar is used for a start-up date is defined and stored.

The calendar definition information 48 is definition data of a calendar.

The business program 43 (batch) is a business program that performs batch processing on business data used in the business system.

The business program 44 (on-line) is a business program that performs processing on business data on-line and in real time.

The business DB 46 is a database from/to which the business programs (batch and on-line) perform reading or recording.

The business DB access log 45 is an access log output in response to an access to a table (information) included in the business DB 46. In the business DB access log 45, an access source, a table name, a user name, an access date, and an access type (update/add) are recorded. Here, the table name and the access type (update/add) are logs based on the SQL issued by a job.

In the job/DB access information 49, information on a table read and recorded by a job is stored when the job scheduler 42 traces an access operation to the business DB 46 by the business program (batch).

A calendar management device 51 includes the integration unit 52, and a memory 53. The memory 53 includes job/table/type relationship information 54, periodicity information 55, and business processing unit information 56. In a storage device of the calendar management device 51, integrated job definition information 57, and integrated calendar definition information 58 are stored.

The integration unit 52 acquires the job definition information 47, the calendar definition information 48, the job/DB access information 49, and the business DB access log 45 from the business system 41. The integration unit 52 determines, based on the business DB access log 45, whether each table of the business DB 46 is a master table or a transaction table. The integration unit 52 combines the determination result with the DB access information of the job, and integrates calendars defined within the job definition information 47 by grouping the calendars.

The integrated job definition information 57 is information in which results of the job definition information 47 in all systems are integrated.

The integrated calendar definition information 58 is information in which results of the calendar definition information 48 in all systems are integrated.

The job/table/type relationship information 54 is information including a connection relationship between a job and a table, a table type, and a purpose type.

The periodicity information 55 is information holding periodicity information of an access to a table.

The business processing unit information 56 is information regarding a business processing unit, and a group of jobs that form the business processing unit.

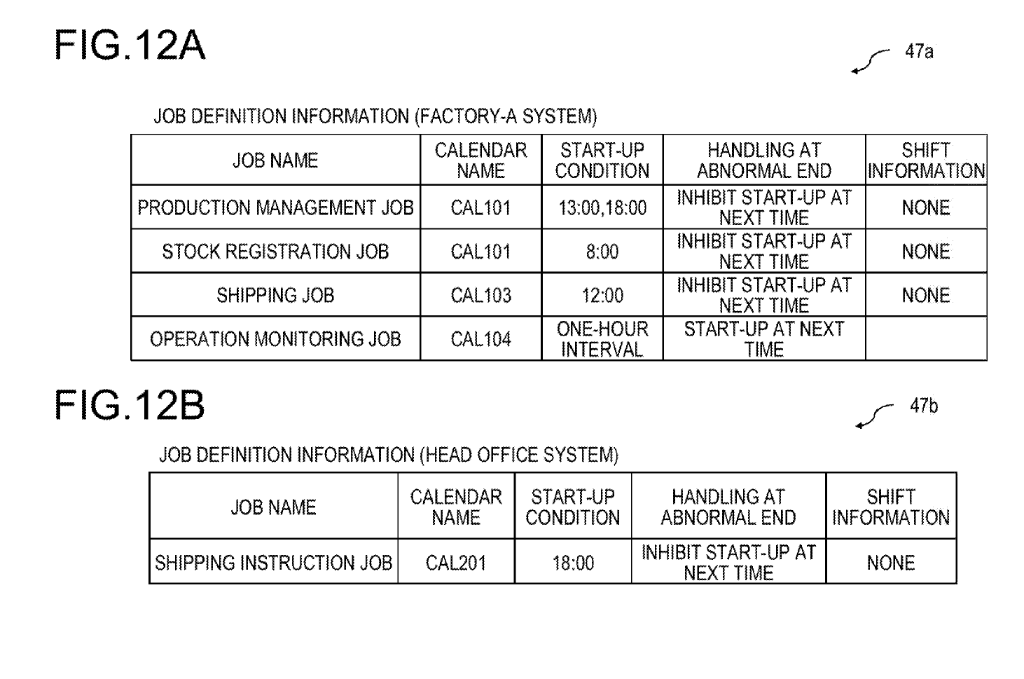

FIGS. 12A and 12B illustrate exemplary job definition information in the present embodiment. FIG. 12A illustrates exemplary job definition information 47a used in the factory-A system 11. FIG. 12B illustrates exemplary job definition information 47b used in the head office system 21.

Respective entries of the job definition information 47 (47a and 47b) include data items of “job name”, “calendar name”, “start-up condition”, “handling at abnormal end”, and “shift information”. In the “job name”, identification information for identifying a job is stored. In the “calendar name”, a name of a calendar is stored. In the “start-up condition”, a timing of starting a job is stored. In the “handling at abnormal end”, whether to perform or inhibit a next time start-up at an abnormal end of a job is stored. In the “shift information”, information indicating days shifted from a date and time registered in a calendar is stored.

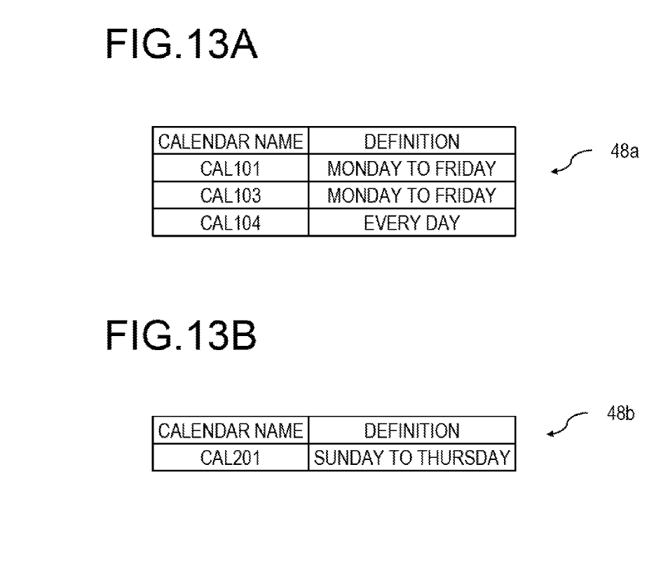

FIGS. 13A and 13B illustrate exemplary calendar definition information in the present embodiment. FIG. 13A illustrates exemplary calendar definition information 48a used in the factory-A system 11. FIG. 13B illustrates exemplary calendar definition information 48b used in the head office system 21.

Respective entries of the calendar definition information 48 (48a and 48b) include items of “calendar name” and “definition”. In the “calendar name”, a name of a calendar is stored. In the “definition”, a date and time corresponding to the calendar (e.g., a factory working day, a business day) is stored.

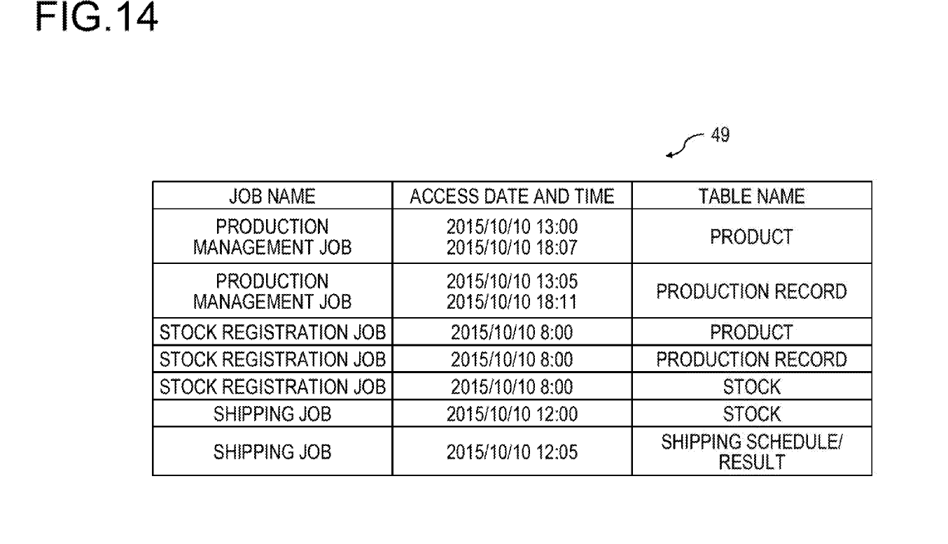

FIG. 14 illustrates exemplary job/DB access information in the present embodiment. Respective entries of the job/DB access information 49 include data items of “job name”, “access date and time”, and “table name”.

In the “job name”, identification information for identifying a job is stored. In the “access date and time”, a date and time the job has accessed a corresponding table is stored. In the “table name”, identification information for identifying the table is stored.

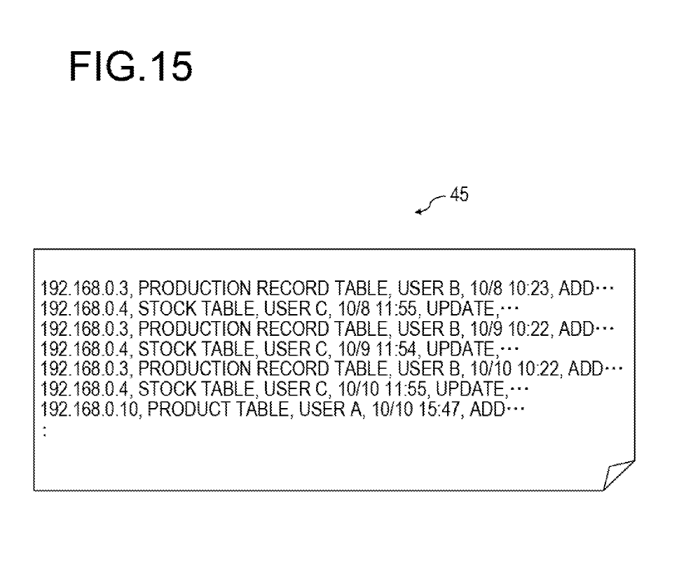

FIG. 15 illustrates an exemplary business DB access log in the present embodiment. When an access to the business DB 46 occurs, information including “access source”, “table name”, “user name”, “access date and time”, and “data manipulation type” is output to the business DB access log 45.

As the “access source”, an Internet protocol (IP) address of an access source is output. As the “table name”, a table name of an access target is output. As the “user name”, a user name having logged in through a terminal of the access source is output. As the “access date and time”, a date and time at which an access to the target table has been made is output. As the “data manipulation type”, a data manipulation (update/add) performed on the target table is output.

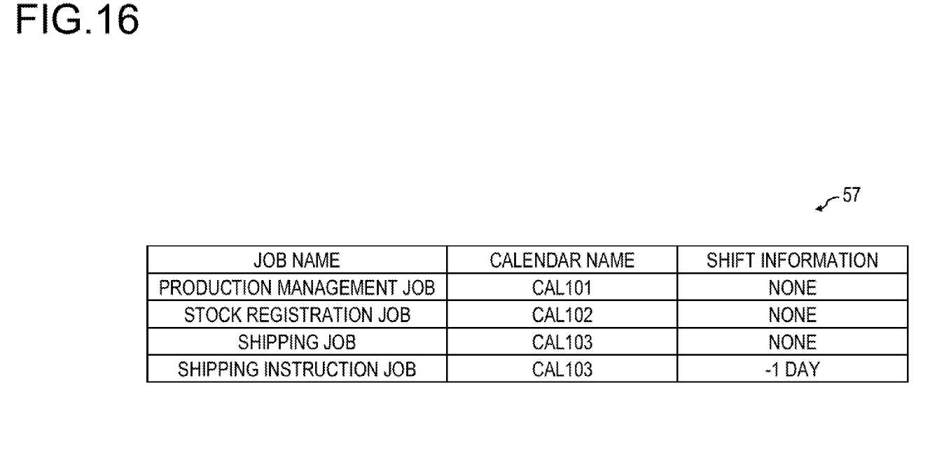

FIG. 16 illustrates exemplary integrated job definition information in the present embodiment. Respective entries of the integrated job definition information 57 include items of “job name”, “calendar name”, and “shift information”. In the “job name”, identification information for identifying a job is stored. In the “calendar name”, identification information for identifying a calendar accessed by the job is stored. In the “shift information”, a date difference between a reference calendar to be described later and a calendar used by a job of the relevant entry before the integration is stored.

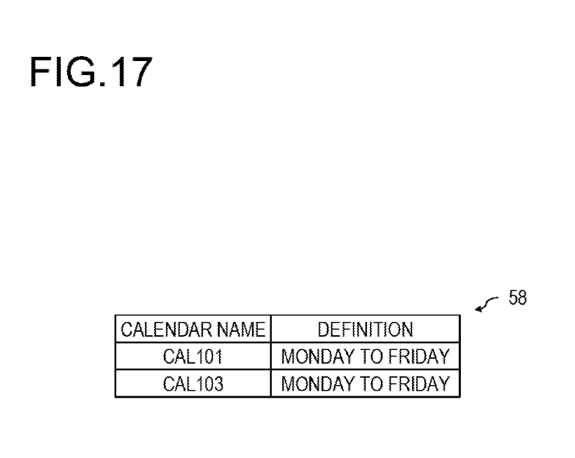

FIG. 17 illustrates exemplary integrated calendar definition information in the present embodiment. Respective entries of the integrated calendar definition information 58 include items of “calendar name” and “definition”. In the “calendar name”, identification information for identifying a calendar is stored. In the “definition”, definition of a calendar (e.g., a date or a day of a week) is stored.

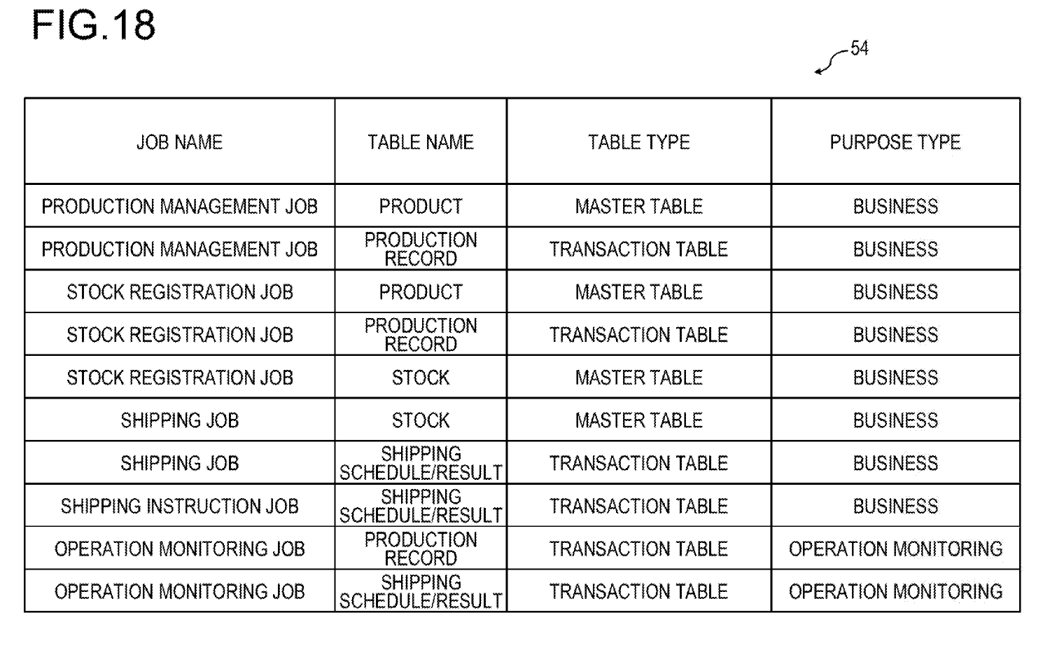

FIG. 18 illustrates exemplary job/table/type relationship information in the present embodiment. Respective entries in the job/table/type relationship information 54 include items of “job name”, “table name”, “table type”, and “purpose type”. In the “job name”, identification information for identifying a job is stored. In the “table name”, identification information for identifying a table is stored. In the “table type”, type information indicating whether the table is a master table or a transaction table is stored. In the “purpose type”, type information indicating whether the purpose of the job is a business operation or operation monitoring is stored.

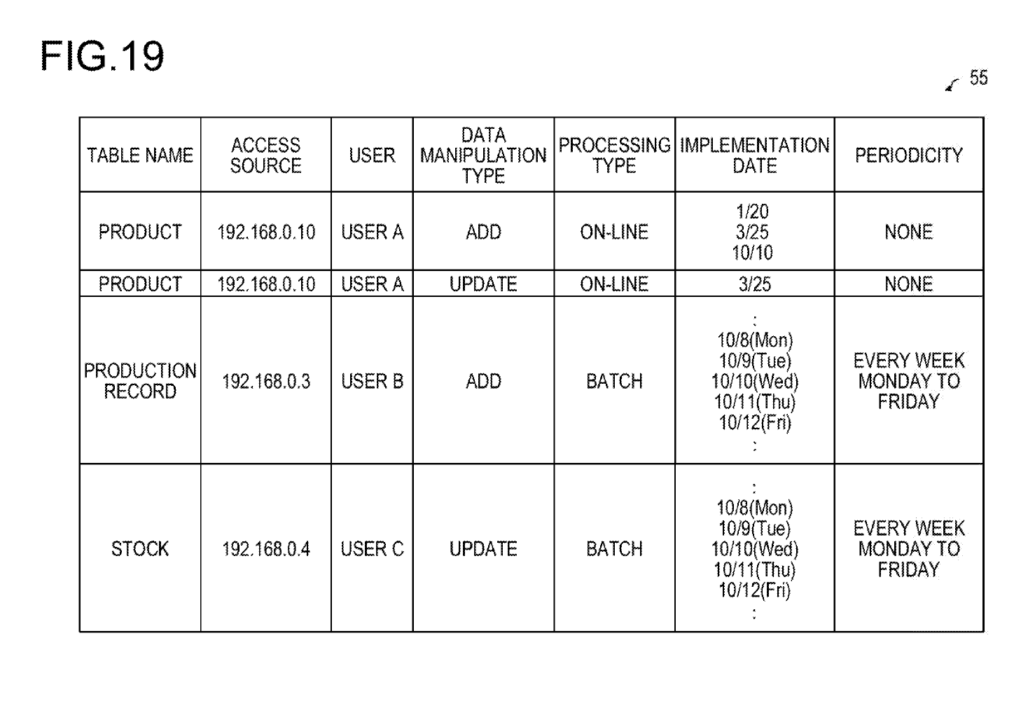

FIG. 19 illustrates exemplary periodicity information in the present embodiment. Respective entries in the periodicity information 55 include items of “table name”, “access source”, “user”, “data manipulation type”, “processing type”“implementation date”, and “periodicity”.

In the “table name”, identification information for identifying a table is stored. In the “access source”, terminal information of an access source for the table is stored. In the “user”, information for identifying a user is stored. In the “data manipulation type”, the content (“update” or “add”) of the data manipulation on the table are stored. In the “processing type”, information as to whether the data manipulation has been performed by batch processing or on-line processing is stored. In the “implementation date”, a date and time the data manipulation has been implemented is stored. In the “periodicity”, a periodicity of execution timings of the data manipulation is stored.

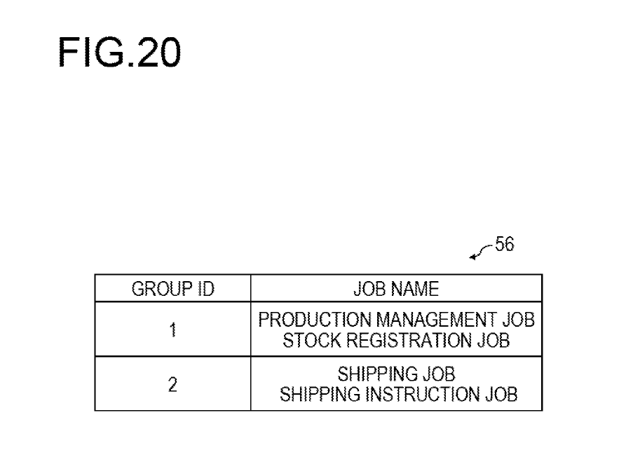

FIG. 20 illustrates exemplary business processing unit information in the present embodiment. Respective entries of the business processing unit information 56 include items of “group ID” and “job name”.

In the “group ID”, identification information for identifying a group is stored. In the “job name”, a name of a grouped job is stored.

Hereinafter, processing in the present embodiment will be described. Descriptions will be made separately in a stage prior to integration of business systems and a virtual integration stage.

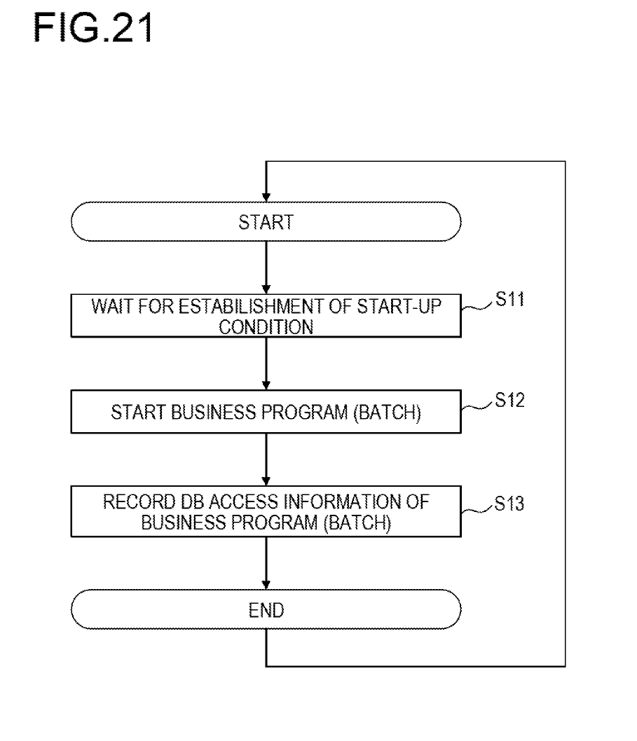

FIG. 21 illustrates an operation flow at the execution of a batch job by a job scheduler prior to integration of business systems, in the present embodiment. In a daily operation stage prior to integration of business systems, the job scheduler 42 performs the following.

The job scheduler 42 waits for establishment of a start-up condition (e.g., in time, file waiting, etc.) in accordance with the definition of the job start-up condition defined in the job definition information 47 (S11).

When detecting the establishment of the start-up condition, the job scheduler 42 starts a target job, here, a business program (batch) (S12). When the job is started, the job accesses the business DB 46 in accordance with the operation condition of the job.

The job scheduler 42 collects an operation trace of the job started in S12, from the business DB 46. When detecting reading/recording processing from/to the business DB 46, the job scheduler 42 stores “job name”, “table name”, and “access date and time” in the job/DB access information 49 (S13).

In a daily operation stage prior to the system integration, a job based on the business program (batch) or the business program (on-line) is operated, thereby causing an occurrence of an access to the business DB 46. In this case, as illustrated in FIG. 15, the job outputs information including “access source”, “table name”, “user name”, “access date and time”, and “access type (update/add)” to the business DB access log 45.

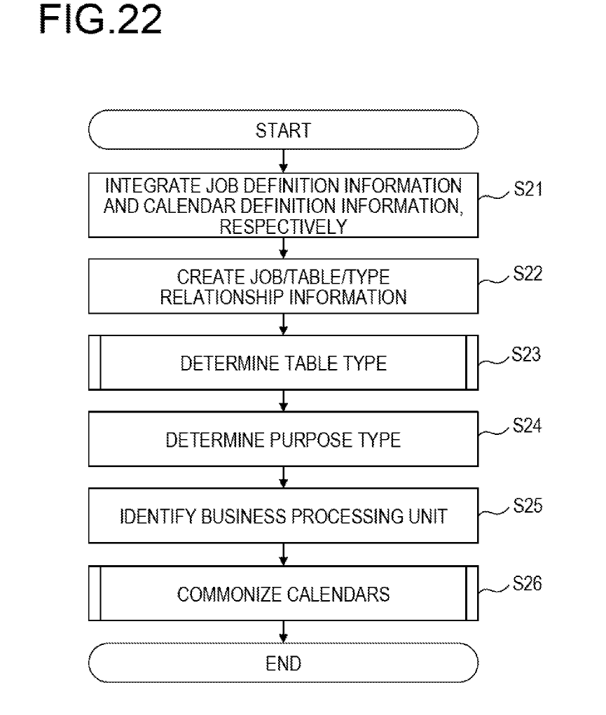

FIG. 22 illustrates a processing flow of an integration unit in a system integration stage in the present embodiment.

The integration unit 52 acquires the job definition information 47 and the calendar definition information 48 from all business systems. The integration unit 52 integrates the acquired job definition information 47 and the acquired calendar definition information 48, and stores the integrated job definition information and the integrated calendar definition information as the integrated job definition information 57 and the integrated calendar definition information 58, respectively (S21).

The integration unit 52 acquires information of a job name and a table name for each entry from the job/DB access information 49 for each business system prior to the integration. The integration unit 52 stores the job name and the table name for each entry, which have been acquired from the job/DB access information 49, in the job/table/type relationship information 54 in association with each other (S22). At this time, table type information within the job/table/type relationship information 54 is placed in an empty state.

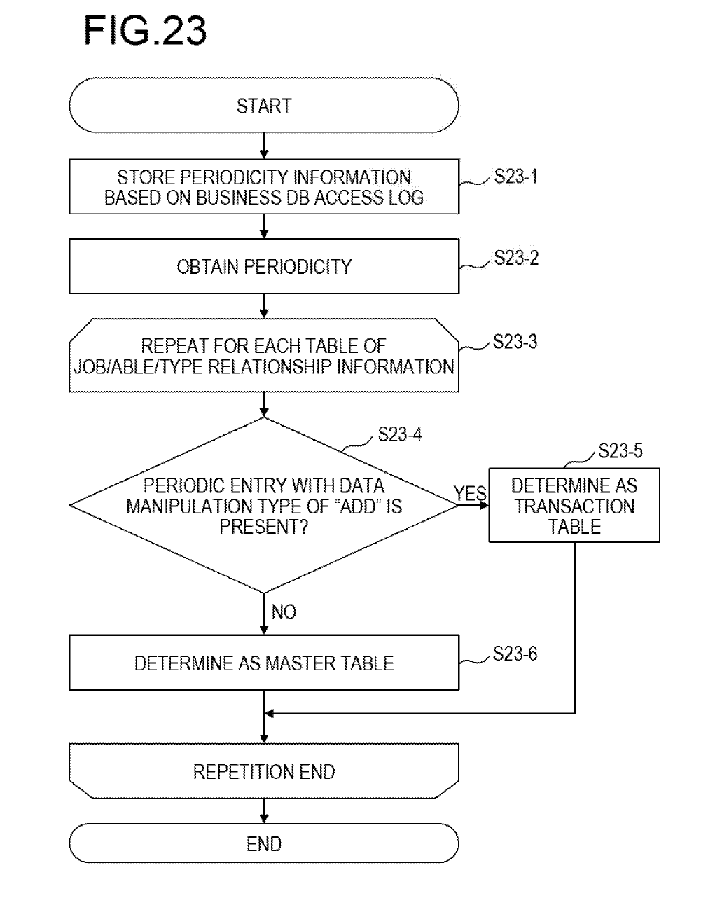

The integration unit 52 determines whether a table type of each table name registered in the job/table/type relationship information 54 is a master table or a transaction table (S23). The details of the determination processing of the table type will be described later in detail with reference to FIG. 23. The integration unit 52 additionally writes the determination result to the table type in the job/table/type relationship information 54.

The integration unit 52 collates each job registered in the job/table/type relationship information 54 to the job definition information 47. When the start-up condition of the collated job is an interval start-up, and a handling at an abnormal end is “start-up at next time”, the integration unit 52 determines that the job for the purpose of an operation monitoring. When the start-up condition of the collated job is not an interval start-up, or a handling at an abnormal end is “inhibit start-up at next time”, the integration unit 52 determines that the job is for the purpose of a business. The integration unit 52 additionally writes the determination result to the purpose type (business/operation monitoring) of the job/table/type relationship information 54 (S24).

The integration unit 52 extracts an entry of which the purpose type is “business purpose” and the table type is “transaction table” from entries registered in the job/table/type relationship information 54. Among jobs included in the extracted entries, the integration unit 52 classifies jobs having a connection relationship through the same table into the same group. The integration unit 52 stores the classification result in the business processing unit information 56 (S25).

For example, it is assumed that job B and job C have a connection relationship with a time card table that is a transaction table, and job C and job D have a connection relationship with a business trip information table that is a transaction table. In this case, the integration unit 52 classifies jobs B, C, and D into the same group, and stores the jobs in the business processing unit information 56.

The integration unit 52 performs commonization for calendars of the jobs included in the same group in the business processing unit information 56 if the commonization is possible (S26).

FIG. 23 illustrates a processing flow of the table type determination (S23) in the present embodiment. The integration unit 52 acquires the business DB access log 45 from all systems. The integration unit 52 extracts “table name”, “access source”, “user name”, “data manipulation type”, and “access date and time” in the following flows (1) to (4), from each entry of the acquired business DB access log 45 of all systems, and stores them in the periodicity information 55 (S23-1).

(1) The integration unit 52 extracts a corresponding entry, using “table name” and “access date and time” of each entry of the job/DB access information 49 as keys, from the business DB access log 45.

At this time, the integration unit 52 determines the processing type (batch/on-line) on the basis of the user name included in the entry extracted from the business DB access log 45. When the user name is a name of a person who has an authority of a predetermined management level, the integration unit 52 determines the processing type as batch. When the user name is not a name of a person who has an authority of the predetermined management level, the integration unit 52 determines the processing type as on-line.

(2) The integration unit 52 removes time information from the access date and time information of the business DB access log 45, thereby converting the information into implementation date information.

(3) The integration unit 52 stores “table name”, “access source”, “user name”, and “data manipulation type” extracted from the business DB access log 45 in the periodicity information 55. Also, the integration unit 52 stores the result determined as described above in (1) in “processing type” of the periodicity information 55. Further, the integration unit 52 stores the implementation date information converted as described in (2) in “implementation date” of the periodicity information 55.

(4) In the periodicity information 55, the integration unit 52 groups “table name”, “access source”, “user name”, “data manipulation type”, and “processing type (batch/on-line)” in this order.

Based on the grouped periodicity information 55, the integration unit 52 calculates a periodicity of an implementation date of an access to a table, for each of the table, the access source, the user name, the data manipulation type, and the processing type. The integration unit 52 registers the calculated periodicity in the item of “periodicity” of the access periodicity information 55. For example, the integration unit 52 sequentially determines whether a periodicity corresponds to a certain interval (e.g., every day, every 3 days), a certain day of each week (e.g., every Monday, every Saturday and Sunday), and a specific date of each month (e.g., the 20th of each month, the 25th and 26th of each month). The integration unit 52 regards a model that is firstly determined to be periodic as a periodicity of a corresponding group (S23-2).

For each table of the job/table/type relationship information 54, the integration unit 52 performs S23-4 (S23-3).

For each table registered in the grouped periodicity information 55, the integration unit 52 determines whether one or more entries having a data manipulation type of “add” are present among the entries having a periodicity for the implementation date of an access. When there are one or more entries having a data manipulation type of “add” among the entries having a periodicity for the implementation date of an access (“YES” in S23-4), the integration unit 52 determines the table as a transaction table (S23-5). Otherwise (“NO” in S23-4), the integration unit 52 determines the table as a master table (S23-6). The integration unit 52 additionally writes the determination result to the item of “table type” of the job/table/type relationship information 54.

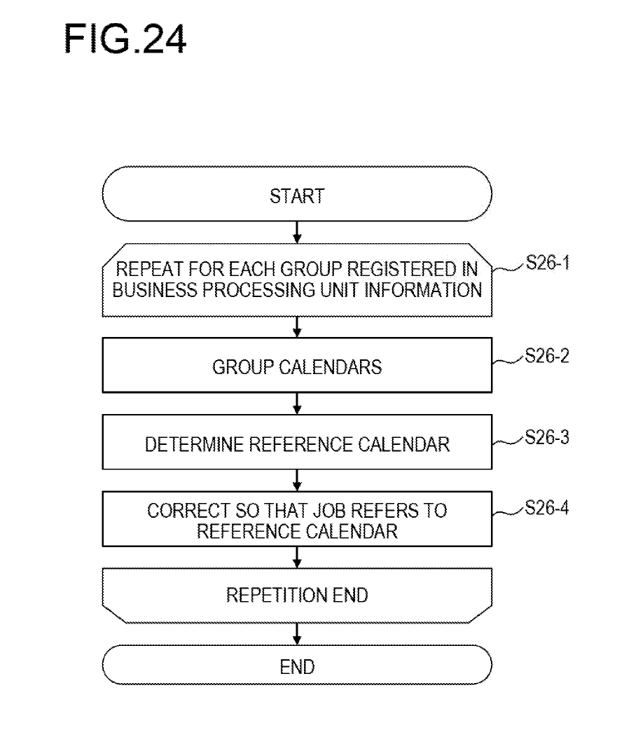

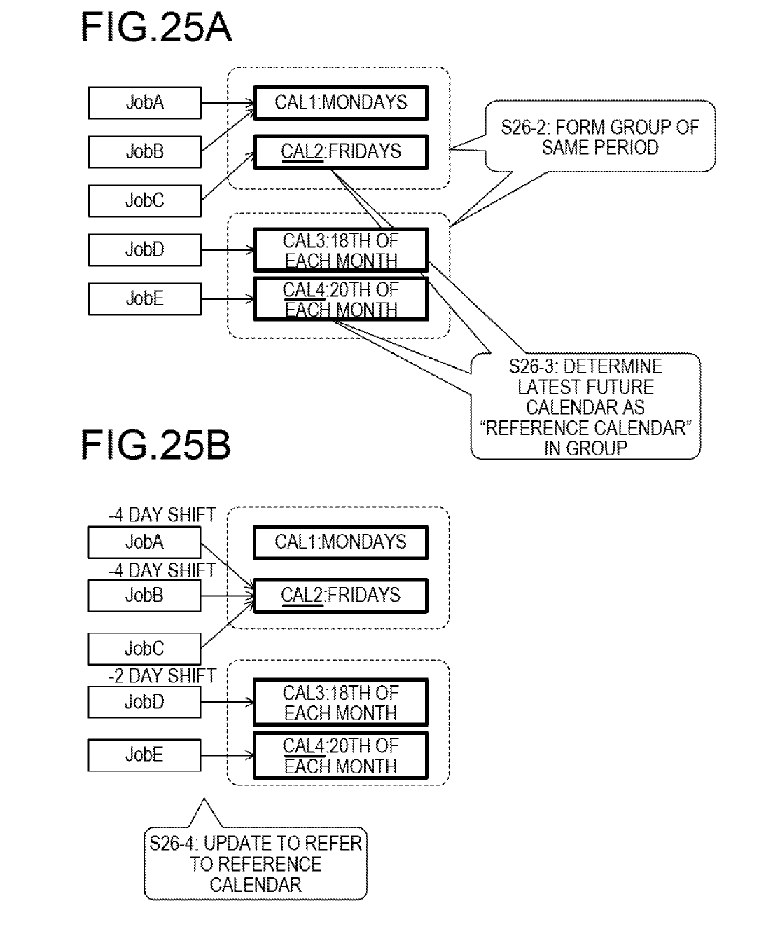

FIG. 24 illustrates a processing flow of the commonization of calendars (S26) in the present embodiment. FIGS. 25A and 25B illustrate commonization of calendars grouped in unit of business processing in the present embodiment. Hereinafter, the processing flow of the commonization of calendars will be described with reference to FIGS. 24, 25A, and 25B.

The integration unit 52 performs the following for each group registered in the business processing unit information 56 (S26-1).

The integration unit 52 performs the following on the basis of the integrated job definition information 57 and the integrated calendar definition information 58. That is, as illustrated in FIG. 25A, the integration unit 52 groups calendars having the same period, among calendars used for reference by respective jobs (set X) within a group of the business processing unit information 56. For a calendar having a certain period not shared by other calendars, the integration unit 52 forms a group including only the calendar (S26-2).

The integration unit 52 determines the latest future calendar as a reference calendar, among grouped calendars having the same period (S26-3). For example, when the period is a week, the integration unit 52 considers Sunday as the latest future day.

The integration unit 52 allows a job in the set X which has originally referred to the reference calendar, to continuously refer to the reference calendar. As illustrated in FIG. 25B, the integration unit 52 updates a calendar name of the integrated job definition information 57 such that a job in the set X which has not referred to the reference calendar, refers to the reference calendar. The integration unit 52 calculates a difference of days between the reference calendar and a calendar that has been originally used for reference, and stores the difference, as shift information, in the integrated job definition information 57 (S26-4).

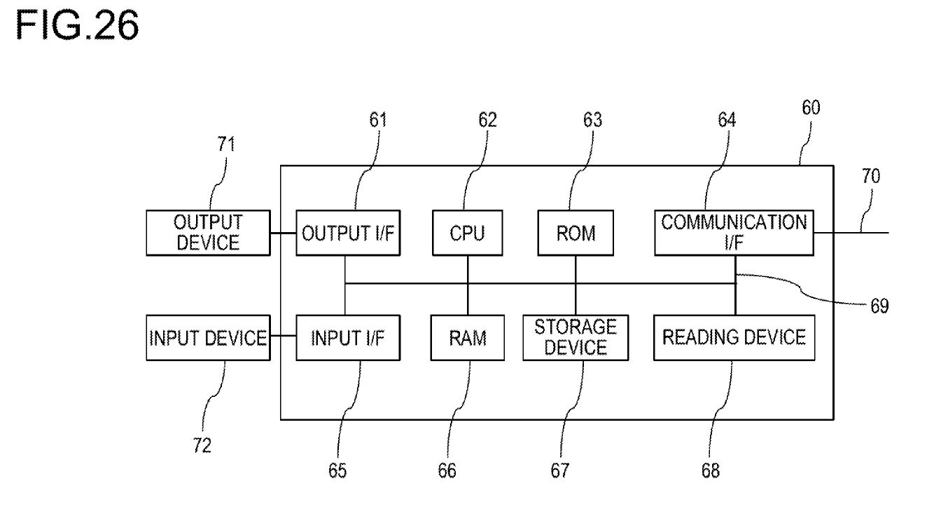

FIG. 26 is an exemplary hardware configuration of a computer that executes a program in the present embodiment. A computer 60 serves as a job execution calendar management device 1 and a calendar management device 31. The computer 60 includes a central processing unit (CPU) 62, a read-only memory (ROM) 63, a random access memory (RAM) 66, a communication interface (I/F) 64, a storage device 67, an output I/F 61, an input I/F 65, a reading device 68, and a bus 69.

The CPU 62, the ROM 63, the RAM 66, the communication I/F 64, the storage device 67, the output I/F 61, the input I/F 65, and the reading device 68 are connected to the bus 69. The reading device 68 is a device for reading a portable recording medium. An output device 71 is connected to the output I/F 61. An input device 72 is connected to the input I/F 65.

As the storage device 67, various types of storage devices such as, for example, a hard disk, a flash memory, and a magnetic disk, may be used. In the storage device 67 or the ROM 63, a program according to the present embodiment is stored to cause the CPU 62 to operate as the acquisition unit 2, the identification unit 3, the grouping unit 4, and the removal unit 5. More specifically, a program according to the present embodiment is stored so that the CPU 62 serves as the integration unit 52.

The storage device 67 stores therein, for example, the integrated job definition information 57, the integrated calendar definition information 58, and the like. In the RAM 66, information such as, for example, the job/table/type relationship information 54, the periodicity information 55, and the business processing unit information 56 is temporarily stored.

The CPU 62, as the controller, reads a program according to the present embodiment from the storage device 67 or the ROM 63, and executes the program.

The communication I/F 64 is an interface such as, for example, a port for connecting to a network to communicate with other devices.

The program for performing the processing described above in the embodiment may be stored in, for example, the storage device 67 through a communication network 70 and the communication I/F 64 from a program provider side. Also, the program for performing the processing described above in the embodiment may be stored in a portable storage medium which is commercially available and in circulation. In this case, the portable storage medium may be set in the reading device 68, so that the program may be read and executed by the CPU 62. As the portable storage medium, various types of storage media such as, for example, a compact disc ROM (CD-ROM), a flexible disk, an optical disk, a magneto-optical disk, an integrated circuit (IC) card, a universal serial bus (USB) memory device, or a semiconductor memory card may be used. The program stored in such a storage medium is read by the reading device 68.

As the input device 72, for example, a keyboard, a mouse, an electronic camera, a web camera, a microphone, a scanner, a sensor, a tablet, or a touch panel may be used. As the output device 71, for example, a display, a printer, or a speaker may be used.

The communication network 70 is connected to a business network. The communication network 70 may be a communication network such as, for example, the Internet, a local area network (LAN), a wide area network (WAN), a dedicated line, and a wired or wireless network.

According to the present embodiment, after virtual integration of batch systems, a business processing unit may be identified from stream of data used in business processing, and whether to integrate calendars may be determined, thereby integrating calendars for the same purpose.

By dividing data used in a batch processing into a master table and a transaction table, the range connected to the transaction table may be identified as a business processing unit.

As a result, through commonization of calendar definitions, the number of management targets may be reduced. Accordingly, when a change of a calendar definition is required, a large number of calendars do not need to be corrected, respectively, but only commonized calendars need to be corrected, thereby reducing an operation and management costs. Also, a possibility that a problem caused by a human error occurs may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
acquiring first pieces of calendar information, access table information, and type information from an information processing system, the first pieces of calendar information respectively indicating timings for starting first jobs, the information processing system starting the first jobs on basis of the first pieces of calendar information, the access table information indicating which one of first tables has been accessed respectively by the first jobs, the type information indicating a type of respective data manipulations performed on the first tables through the accesses by the first jobs;
identifying transaction tables among the first tables on basis of the type information, the transaction tables storing information added by any one of the first jobs; and
grouping second pieces of calendar information among the first pieces of calendar information on basis of the access table information, the second pieces of calendar information corresponding to second jobs among the first jobs, the second jobs accessing a same transaction table among the transaction tables.

2. The non-transitory computer-readable recording medium according to claim 1, the process comprising:
identifying a second table among the first tables as a transaction table when the type information indicates addition of data to the second table.

3. The non-transitory computer-readable recording medium according to claim 1, the process comprising:
removing third jobs from the first jobs on basis of job definition information, the job definition information defining a start-up condition and an operation in a case of an abnormal end for the first jobs, the third jobs being defined to be started at a constant time interval as the start-up condition and to be restarted in a case of the abnormal end in the job definition information.

4. The non-transitory computer-readable recording medium according to claim 1, the process comprising:
extracting the second pieces of calendar information to integrate the second pieces of calendar information.

5. The non-transitory computer-readable recording medium according to claim 4, the process comprising:
dividing the second pieces of calendar information into one or more groups on basis of a calendar period;
selecting a reference piece of calendar information from a first group of the groups;
associating jobs corresponding to other pieces of calendar information in the first group with the reference piece of calendar information; and
storing a difference of days between the other pieces of calendar information and the reference piece of calendar information.

6. A job execution calendar management device, comprising:
a processor configured to
acquire first pieces of calendar information, access table information, and type information from an information processing system, the first pieces of calendar information respectively indicating timings for starting first jobs, the information processing system starting the first jobs on basis of the first pieces of calendar information, the access table information indicating which one of first tables has been accessed respectively by the first jobs, the type information indicating a type of respective data manipulations performed on the first tables through the accesses by the first jobs,
identify transaction tables among the first tables on basis of the type information, the transaction tables storing information added by any one of the first jobs, and
group second pieces of calendar information among the first pieces of calendar information on basis of the access table information, the second pieces of calendar information corresponding to second jobs among the first jobs, the second jobs accessing a same transaction table among the transaction tables.

7. A job execution calendar management method, comprising:
acquiring, by a computer, first pieces of calendar information, access table information, and type information from an information processing system, the first pieces of calendar information respectively indicating timings for starting first jobs, the information processing system starting the first jobs on basis of the first pieces of calendar information, the access table information indicating which one of first tables has been accessed respectively by the first jobs, the type information indicating a type of respective data manipulations performed on the first tables through the accesses by the first jobs;
identifying transaction tables among the first tables on basis of the type information, the transaction tables storing information added by any one of the first jobs; and
grouping second pieces of calendar information among the first pieces of calendar information on basis of the access table information, the second pieces of calendar information corresponding to second jobs among the first jobs, the second jobs accessing a same transaction table among the transaction tables.
